(19) United States
(12) Patent Application Publication
(10) Pub. No.: US 2005/0008167 A1
(43) Pub. Date: Jan. 13, 2005

(54) Device for picking up/reproducing audio signals

(76) Inventors: Achim Gleissner, Barienrode (DE); Rolf Meyer, Wennigsen (DE); Volker Rhenius, Wedemark (DE); Nils Oliva, Garbsen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/836,082

(22) Filed: Apr. 30, 2004

(30) Foreign Application Priority Data
Apr. 30, 2003 (DE) 103 19 751.6
Dec. 4, 2003 (DE) 103 57 065.9

(51) Int. Cl. H04R 1/10; H04B 15/00

(52) U.S. Cl. 381/74; 381/384; 381/71.6

(57) ABSTRACT

A headset is provided which comprises a first microphone unit for picking up air-borne noise, a second microphone unit for picking up audio signals based on solid-borne noise and an addition unit for combining the output signals of the first and second microphone units.

### CROSS-REFERENCE TO RELATED APPLICATIONS

This application claims priority of German Application No. 103 19 751.6, filed Apr. 30, 2003 and German Application No. 103 57 065.9, filed Dec. 4, 2003, the complete disclosures of which are hereby incorporated by reference.

### BACKGROUND OF THE INVENTION

a) Field of the Invention

The present invention relates to a headset, a device for picking up and reproducing audio signals, a seat with such a device and a hands-free unit having such a device.

b) Description of the Related Art

So-called listening-speaking headsets are known as headsets, in which a microphone arm is connected to a headphone. A microphone mounted on the microphone arm picks up audio signals produced by a user or wearer. In this case the microphone and also the microphone arm are configured in such a manner that the microphone is located in the vicinity of the user's or wearer's mouth so as to obtain the best possible recording quality. The microphone signal picked up by this microphone is normally transmitted in wire-bound or wireless manner to another site or is possibly correspondingly recorded. If the microphone is disposed relatively close to the user's mouth and the user is situated in a peaceful location, a good recording quality can be obtained. However, a peaceful location is the exception in many areas, so that satisfactory recording quality has a disadvantageous effect on the intelligibility of the words spoken into and recorded in the microphone.

To lessen the above-mentioned problem, directional microphones are installed in the microphone arm, the directional characteristic of which is directed to the user's mouth. Although this immediately causes an improvement in recording quality, such a solution is however not satisfactory in noise-filled environments in particular.

So-called throat microphones were therefore used in such, particularly noise-filled, environments. These microphones are based on picking up solid-borne noise at the larynx of a wearer and thus directly pick up the mechanical vibrations which a human larynx produces when talking. In contrast to the above-mentioned microphone, a throat microphone only picks up solid-borne noise, but not air-borne noise. Thus picking up of the ambient noise is prevented, but the hissing or explosive sounds formed in particular in the front mouth area cannot be picked up with such a microphone. This proves to be disadvantageous since the hissing or explosive sounds make a not inconsiderable contribution to voice intelligibility. Thus audio signals or speech picked up by means of such a throat microphone can only be understood with great difficulty, as a result of which such throat microphones can only be used to a limited extent.

Another possibility of detecting solid-borne noise is represented by the detection of the vibrations of the cranial bones of a user. In this case, however, the disadvantages described above are also produced, namely the fact that the hissing and explosive sounds are not also transmitted in the solid-borne noise.

In many new audio applications, however, voice intelligibility is gaining importance. For example, systems have been developed which have active noise compensation. Such a system is shown in DE 195 26 124. The device shown there with active noise compensation is based on the principle of phase-inverse sound.

For this, at the noise exposure site, e.g. at the ear, by means of a sound pick-up in the form of a microphone, the sound wave arriving at the ear is supplied to a filter for 180° shifting and the phase-shifted noise is then delivered via a transducer to the ear.

A combination of such active noise compensation devices with passive ear protection, such as a closed headphone, for example, may be achieved in the lower frequency range [of] a noise reduction of more than 15 dB, with a noise reduction of 10 dB already being perceived as halving the loudness.

Other examples of such headphones with active noise compensation are known under the designation “NoiseGard” (trademark of Sennheiser electronic KG).

Such headphones have proved their worth, in particular in aviation, since the subjectively perceived noise is reduced and communication with air traffic control is made considerably easier.

On the other hand, such listening-speaking headsets are not accepted in many other areas, as it is perceived to be unpleasant to wear a large headphone.

### OBJECT AND SUMMARY OF THE INVENTION

Thus the primary object of the present invention is to provide a headset which ensures improved picking up of audio signals in particular in a noise-filled environment and to improve listening and speaking devices with active noise compensation with respect to their flexibility and also operating and wearing comfort.

This object is achieved by a headset in accordance with the invention, by a device for picking up and reproducing audio signals according to the invention, by a seat having a device for picking up and reproducing audio signals in accordance with the invention and by a hands-free unit having such a device in accordance with the invention.

Therefore a headset is provided which comprises a first microphone unit for picking up air-borne noise, a second microphone unit for picking up audio signals based on solid-borne noise and an addition unit for combining the output signals of the first and second microphone units.

In accordance with an embodiment of the invention, the air-borne noise picked up by the first microphone unit is subjected to highpass filtering. Since the first microphone unit accordingly only picks up or relays high-frequency audio signals, i.e. the hissing or explosive sounds, for example, the low-frequency and medium-frequency sound components, which make up a considerable proportion of the ambient noise, are not picked up by the first microphone unit or only after strong damping. The second microphone unit only picks up audio signals which are based on the solid-borne noise, so that here too the ambient noise is not picked up or transmitted. During this picking up, the audio signals generated by the noisy environment are therefore suppressed in an effective manner. Only by combining the output signals of the first and second microphone units does the resultant signal thus contain all those voice components which are useful or necessary for understanding and which are simultaneously freed from interfering signals of the ambient noise.

In accordance with an embodiment of the invention, the headset also comprises a wind noise-damped region in which the second microphone unit for picking up audio signals based on solid-borne noise is disposed. Thus a damping of the air-borne noise, i.e. the ambient noise, is achieved so that the second microphone unit picks up the ambient noise to a lesser extent.

In accordance with another embodiment of the invention, a wind noise-damped region is constructed by a region between a headphone and the ear or the auditory canal of the wearer of the headset. Therefore both a damping of the ambient noise and also a bidirectional communication can be achieved by means of the headset.

In accordance with another embodiment of the invention, the headphone comprises an active wind noise suppression unit. By means of the active wind noise suppression, the effect of the ambient noise can be further reduced and a wind noise-damped region can be actively obtained.

In accordance with another embodiment of the invention, the first and/or second microphone unit is used to pick up the wind noise for the active wind noise suppression. Thus one microphone can be dispensed with or the microphone already provided for the active wind noise suppression may also be used to pick up audio signals based on solid-borne noise.

The invention is also based on the concept of using the microphone, which in known devices is used for active noise compensation to pick up the wind noise, also to pick up voice signals.

Consequently, a device for picking up and reproducing audio signals is provided, which comprises a microphone which is suitable both for picking up wind noise and also for picking up voice signals. The audio signals picked up by the microphone are supplied to an active noise compensation device, which is suitable for generating a signal for the compensation of wind noise. This signal for wind noise compensation is supplied to a reproduction transducer which then outputs this signal. The device also comprises a filter device for filtering voice signals from signals picked up by the microphone, which can be outputted by means of an output device.

By using the microphone for recording wind noise also to record voice signals, the complexity of known devices for picking up and reproducing audio signals is reduced by the fact that just one microphone instead of two microphones has to be provided. This one microphone is designed so that it can pick up the wind noise and also the voice signals to be processed, as a result of which the costs and also the weight of the device can be reduced.

In accordance with one aspect of the invention, the device is configured in such a manner that it is suitable to be housed in a seat.

Thus the device may also be used as a hands-free unit. In other words: the device does not have to be constructed as a headphone, for example, but may be implemented in a seat so that wearing comfort is considerably increased.

The invention also relates to a seat and also a hands-free unit with a device, described above, for picking up and reproducing audio signals.

Further embodiments of the invention are the subject matter of the present invention.

The invention is described in detail below with reference to the drawings.

### BRIEF DESCRIPTION OF THE DRAWINGS

In the drawings:

FIG. 1 shows a schematic block diagram of a headset in accordance with a first exemplified embodiment of the invention;

FIG. 2 shows a schematic block diagram of a headset in accordance with a second exemplified embodiment of the invention;

FIG. 3 shows a schematic block diagram of a headset in accordance with a third exemplified embodiment of the invention; and

FIG. 4 shows a basic block diagram of the device for picking up and reproducing audio signals.

### DESCRIPTION OF THE PREFERRED EMBODIMENTS

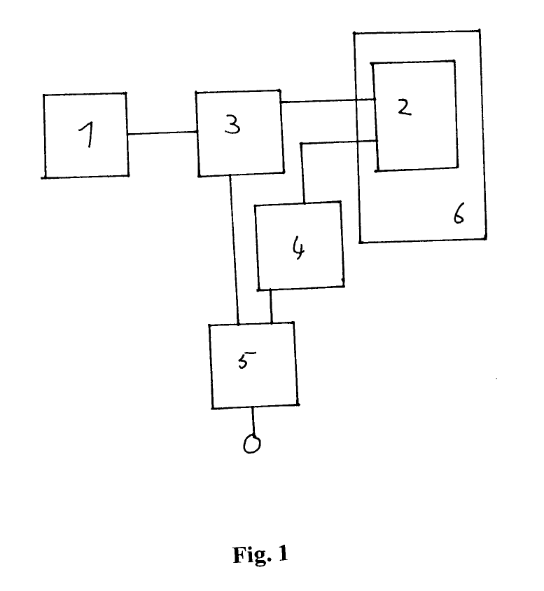

FIG. 1 shows a schematic block diagram of the functional units of a headset in accordance with a first exemplified embodiment. The headset comprises a microphone 1, a headphone 6 with an integrated microphone 2, an addition unit 3, a wind noise suppression unit 4 and also an input/output unit 5.

The headphone 6 is positioned over an ear or a user or wearer of the headset, while the microphone 1 is aligned in a region close to the mouth of a user of the headset. The microphone 1 picks up the words spoken by the user of the headset and also any accordingly present ambient noise. Simultaneously with this, the second microphone 2 in the headphone 6 picks up the audio signal transmitted by the cranial bones of the user which is based on solid-borne noise. As the headphone 6 dampens the air-borne noise or wind noise reaching an ear of the headset wearer, the second microphone 2 only records the audio signal based on solid-borne noise. The output signals of the first and second microphones 1, 2 are relayed to the addition unit 3. In the addition unit 3 the two output signals are combined and relayed to an input/output unit 5. The input/output unit 5 can relay these signals to a following signal processing unit.

Additionally to the damping of the air-borne noise or wind noise caused by the headphone 6, active wind noise suppression can also be used. For this, the wind noise signal picked up by the second microphone is relayed to the wind noise suppression electronics, which generate a wind noise-damped region 4. Such an active wind noise compensation is described in detail in EP 0 737 022.

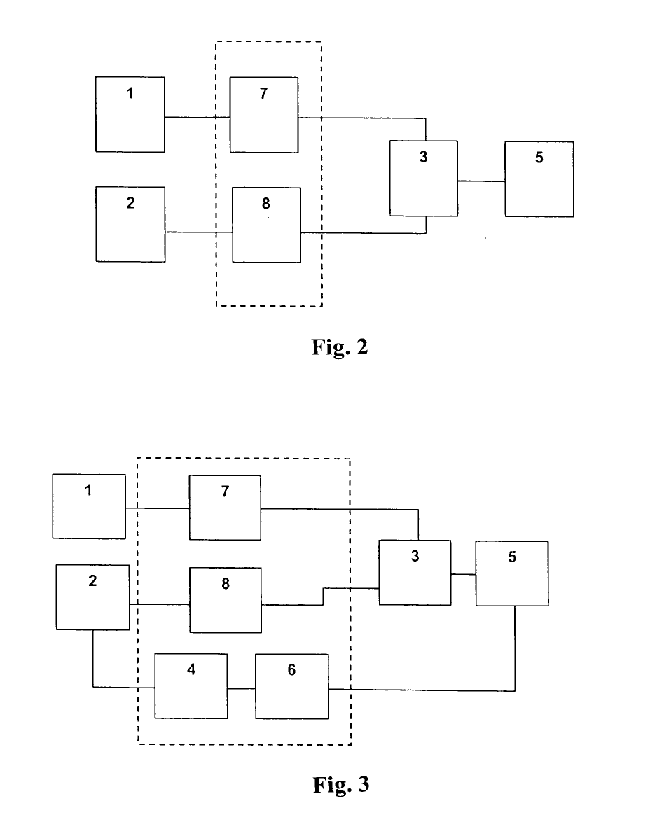

FIG. 2 shows a schematic block diagram of a headset in accordance with a second exemplified embodiment of the invention. The headset comprises a first microphone 1 for picking up air-borne noise, a second microphone for picking up audio signals based on solid-borne noise (air-borne noise and/or solid-borne noise) and an addition unit 3 and an input/output unit 5. The first microphone 1 picks up air-borne noise, while the second microphone 2 picks up audio signals based on solid-borne noise simultaneously with this. A highpass unit 7 may optionally be provided between the first microphone 1 and the addition unit 3. Alternatively to this, the highpass unit 7 may also be integrated into the first microphone 1 or in the addition unit 3. A lowpass unit 8 may optionally be disposed between the second microphone 2 and the addition unit 3. Alternatively to this, the lowpass unit 8 may be integrated in the second microphone 2 or in the addition unit 3. The air-borne noise picked up by the first microphone 1 experiences highpass filtering, which is implemented in the first microphone 1, between the first microphone 1 and the addition unit 3 or in the addition unit 3. The audio signals picked up by the second microphone 2 and based on solid-borne noise are subjected to lowpass filtering, which is implemented in the second microphone 2, between the second microphone 2 and the addition unit 3 or in the addition unit 3. The second microphone 2 can be configured as a solid-borne noise microphone or as a microphone for picking up air-borne noise produced by the solid-borne noise. The highpass or lowpass filtering can be integrated into the respective microphone in a type-specific manner, i.e. acoustically or electrically, but alternatively to this the highpass or lowpass filtering may also be implemented electrically in the addition unit 3.

If the second microphone 2 is configured as a pure solid-borne noise microphone, it does not pick up any air-borne noise at all or only very slight air-borne noise. However, if the second microphone 2 is configured as an air-borne noise microphone, it may be disposed in a region which is damped to air-borne noise in relation to the ambient noise so that it is not disturbed or adversely affected by the ambient noise. In this case the second microphone 2 then picks up the air-borne noise which is produced by the solid-borne noise of the person wearing the headset, i.e. the vibrations of the bone (solid-borne noise) generate air-borne noise.

The highpass and lowpass filters 7, 8 surrounded by broken lines are optional. They may be used together as a combination or individually.

FIG. 3 shows a schematic block diagram of a headset in accordance with a third exemplified embodiment of the invention. As in the first and second exemplified embodiments, a first microphone 1 for picking up air-borne noise and a second microphone 2 for picking up audio signals based on solid-borne noise are provided. Furthermore, an addition unit 3 is provided, which combines the signals of the first and second microphones 1, 2. As described in the second exemplified embodiment, the air-borne noise recorded by the first microphone 1 can be subjected to highpass filtering. This may take place acoustically in the first microphone 1, electronically in the first microphone 1, electronically between the first microphone 1 and the addition unit 3 and/or electronically in the addition unit 3. The audio signals based on solid-borne noise from the second microphone 2 may be subjected to lowpass filtering. This lowpass filtering may take place acoustically in the second microphone 2, electronically in the second microphone 2, electronically between the second microphone 2 and the addition unit 3 and/or electronically in the addition unit 3.

The headset according to the third exemplified embodiment of the invention also comprises a wind noise-damped region and a headphone 6. The wind noise-damped region may be produced both actively by an active wind noise suppression 4 by an electronic wind noise compensation or passively by the ear cushion of the headphone 6. The headphone 6 may thus form a wind noise-damped region. The second microphone 2 is preferably disposed in the wind noise-damped region, i.e. the second microphone 2 for picking up audio signals based on solid-borne sound is integrated into the headphone 6 or disposed there.

The components surrounded by a broken line, i.e. the highpass and lowpass filters 7, 8, the active wind noise suppression unit 4 and the headphone 6 are optional. They may be used together as a combination or individually.

The highpass and lowpass filtering mentioned in the second and third exemplified embodiments of the invention may be implemented optionally by electrical and/or acoustic means in the respective microphones themselves or by electrical means in the addition unit 3. Alternatively to this, the highpass or lowpass filtering may also be electronically implemented between the respective microphones and the addition unit.

The above-described headphones may be implemented, for example, by a headphone with a closed design, as a result of which the ear is screen from the ambient noise, i.e. the ambient noise only reaches the ear after dampening. The microphone 2 may either directly pick up the solid-borne sound by it being mounted directly preferably on a cranial bone, or it can record the air-borne noise which is produced in the closed volume of the headphone and is based on the solid-borne sound of the cranial bone or the vibrations of the bones. When the wearer of the headset talks, the voice signal will occur as air-borne noise in the volume in front of the ear and also in particular in the region of the auditor canal on account of the vibrations of the cranial bones. In this case this signal picked up by the second microphone 2 is free from the sounds which are produced in the front mouth area, in particular in the lip area.

A corresponding situation also applies for protective earphone, which with their ear cushion screen the auditory canal from the ambient noise. As described above, the voice signal of the person wearing the protective earphone, which is formed by the vibration of the cranial bones, will also occur in the volume of the auditory canal.

In the case of a headphone having active noise compensation, a space is created between the headphone and the ear, i.e. also in the auditory channel, in which the loudness level of the ambient noise is significantly reduced. The microphone is mounted in this space and also records this ambient noise only to a reduced extent. Simultaneously with this, this second microphone picks up the voice signal which is produced from the vibrations of the cranial bones. This voice signal is relayed to a wind noise suppression unit 4 so that active wind noise compensation can be performed.

The first microphone 1 comprises highpass behaviour so that only higher frequency signals such as, for example, hissing sounds and explosive noises are recorded. Thus the signals recorded by the second microphone 2 may be supplemented by the hissing sounds and the explosive sounds. This has proved to be advantageous to the extent that the low-frequency and medium-frequency noise components, which make up a substantial proportion of the ambient noise, are recorded only with very strong damping. The highpass transmission behaviour of the first microphone 1 can be produced by acoustic measures or by electrical measures.

Alternatively, the above-described wind noise suppression may also be implemented based on ear protection.

In accordance with the present invention, audio signals based on solid-borne noise may be represented as solid-borne signals and also air-borne signals which were produced by solid-borne noise.

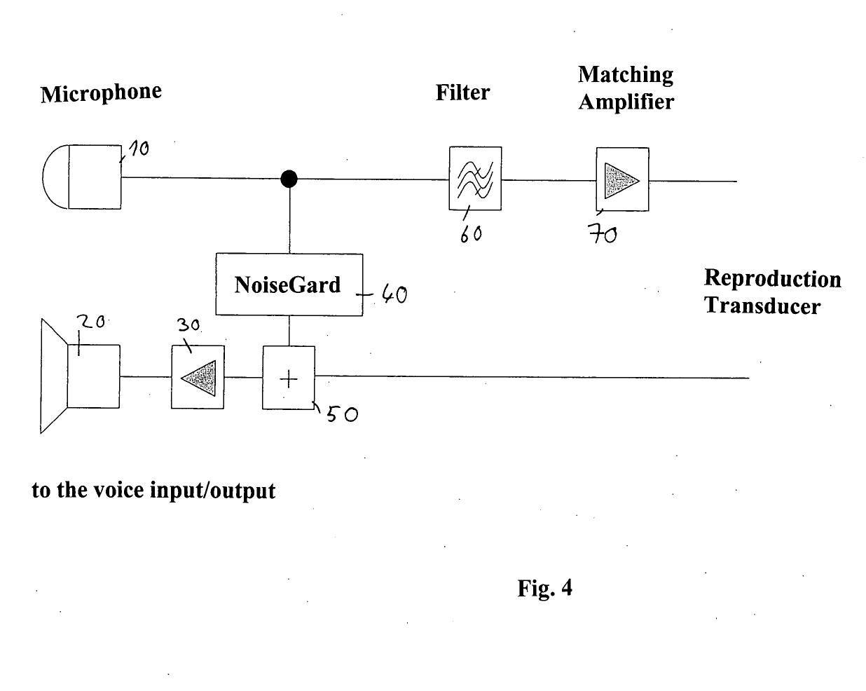

FIG. 4 shows a block diagram of a device for picking up and reproducing audio signals in accordance with a fourth exemplified embodiment. The device comprises a microphone 10, a reproduction transducer 20, an amplifier 30, an active noise compensation device 40, a summing element 50, a filter 60 and also a matching amplifier 70. The microphone 10 is connected to the active noise compensation device 40 and also to the filter 60. The device can be connected to an external telecommunications device, for example.

The microphone 10 receives both wind noise and also voice signals and relays these signals to the active noise compensation device 40 and to the filter 60, which filters the voice signals out of this signal and relays the filtered-out voice signals to a matching amplifier 70. The matching amplifier 70 amplifies the filtered voice signals and outputs them to an external telecommunications device.

The active noise compensation device 40 relays the signals received from the microphone 10 to a filter for 180° shifting and outputs the phase-shifted noise as an output signal. This phase-shifted noise is added by the summing device 50 to the signals which are supplied from an external telecommunications device. The phase-shifted signals from the active noise compensation device 40 and the signals from the external telecommunications device are amplified by the amplifier 30 and are outputted to the reproduction transducer 20.

In accordance with a first exemplified embodiment, both the microphone and also the transducer are provided in a headphone.

The operating principle of active noise compensation is described in further detail in DE 195 26 124, DE 95 134, DE 3 05 391, DE 71 754, DE 71 534, DE 6 55 508, DE 37 19 93, DE 40 153, DE 8 81 597, EP 008 389, GB 1 47 166, GB 16,074, GB 1,600,70, GB 09 769, GB 1 530 814, DE 33 498, DE 31 37 747, DE 1 51 717, EP 0 46 1801, U.S. Pat. No. 4,736,431, U.S. Pat. No. 4,494,074, U.S. Pat. No. 4,05,734, U.S. Pat. No. 4,017,797, U.S. Pat. No. 3,637,940, U.S. Pat. No. 3,637,040, U.S. Pat. No. 4,922,542, U.S. Pat. No. 4,922,542, U.S. Pat. No. 4,399,334, U.S. Pat. No. 260,030 and U.S. Pat. No. 1,807,225. The special configuration of the active noise compensation device may be performed in accordance with the above-mentioned documents.

In accordance with a fifth exemplified embodiment, both the microphone 10 and also the reproduction transducer 20 are not provided in a headphone or not in a direct communication with a user's head, but both the microphone 10 and also the transducer 20 are provided in the vicinity of a user's head. Thus the transducer and the microphone can be disposed in a head rest of a driver's seat or a passenger seat in a bus, aeroplane or a train. In this case it should be noted that the microphone is located in three-dimensional proximity to the reproduction transducer so that the active noise compensation can function sufficiently well.

Apart from the telecommunication device, the device may also be connected to appliances processing other audio and video data.

By arranging the device or the microphone 10 and the reproduction transducer 20 on a seat, the user no longer has to wear a headphone, which contributes considerably towards increasing the wearing and operating comfort. Moreover, hands-free units which have good voice intelligibility may thus be provided.

The device according to the invention may also be equipped with a voice input device, which may serve to control the device according to the invention by mans of voice control, for example to set parameters of the noise compensation device of the filter or also the output device. For this it is necessary that a voice input device is provided, in which case a voice memory is also contained in which there is an association of the voice inputs to individual machine commands, for example to be able to control parameters of the device in a desired and purposeful manner.

It is also possible with the present invention that when an error occurs in the device according to the invention, the error message is produced by means of the voice output device by a corresponding error catalogue being stored with the relevant voice outputs and upon the occurrence of an error, the corresponding voice output being triggered once, several times, automatically or by the operator controlling a device according to the invention.

Furthermore, error messages in particular can be outputted in a vehicle by means of the above-described arrangement as voice output. In this case it is advantageous that by the active noise compensation the voice output of the error has improved voice intelligibility, which is advantage in the case of urgent error messages in particular. A postconnected processing device may be connected to a bus of a vehicle, for example, in order to output error messages of the bus as a voice output. The reproduced voice output may have been stored in advance. In other words, a certain library of possible error messages or their voice output is therefore to be recorded in advance.

Depending on the importance of these error messages, these can be reproduced with varying loudness and be announced in advance by means of different tones.

In accordance with another exemplified embodiment of the invention, the headset described in the first to third exemplified embodiments may be combined with the device for picking up and reproducing audio signals in accordance with the fourth and fifth exemplified embodiments. The first and second microphone units 1, 2 of the headset according to the first to third exemplified embodiments may be used as a microphone 10 in the device for picking up and reproducing audio signals. The following audio processing of the audio signals picked up by the first and second microphone units 1, 2 may take place behind the matching amplifier 70, for example. The reproduction transducer 20 according to the fourth and fifth exemplified embodiments may also be designed as a headset.

In accordance with another exemplified embodiment of the invention, the processing of audio signals described in accordance with the fourth and fifth exemplified embodiments and in particular the active noise compensation may be formed by the active noise compensation device 40.

While the foregoing description and drawings represent the present invention, it will be obvious to those skilled in the art that various changes may be made therein without departing from the true spirit and scope of the present invention.

1. A headset comprising:
a first microphone unit for picking up air-borne noise;
a second microphone unit for picking up audio signals based on solid-borne noise; and
an addition unit for combining the output signals of the first and second microphone units.

2. A headset according to claim 1, wherein the air-borne noise picked up by the first microphone unit is subjected to highpass filtering.

3. A headset according to claim 1, further comprising a wind noise-damped region, wherein the second microphone unit is disposed in the wind noise-damped region.

4. A headset according to claim 1, further comprising a wind noise-damped region formed by a headphone.

5. A headset according to claim 4, wherein the headphone comprises an active wind noise suppression unit.

6. A headset according to claim 5, wherein the first and/or the second microphone unit is suitable for picking up the wind noise signal used for the suppression of the wind noise.

7. A headset according to claim 6, wherein the first microphone unit comprises electrical and/or acoustic means for the realisation of the highpass filtering of the picked up air-borne noise.

8. A headset according to claim 2, wherein electrical means for the realisation of the highpass filtering of the picked up air-borne noise are disposed between the first microphone unit and the addition unit or in the addition unit.

9. A headset according to claim 2, wherein the second microphone unit comprises electrical and/or acoustic means for the realisation of the lowpass filtering of the picked up audio signals based on solid-borne noise.

10. A headset according to claim 2, wherein electrical means for the realization of the lowpass filtering of the picked up audio signals based on solid-borne noise are disposed between the second microphone unit and the addition unit or in the addition unit.

11. A device for picking up and reproducing audio signals, comprising:
a microphone for picking up wind noise and voice signals;
an active noise compensation device which is connected to the microphone to generate a signal for the wind noise compensation;
a reproduction transducer for outputting the signal for wind noise compensation;
a filter device for filtering voice signals from the signals picked up by the microphone; and
an output device for outputting the filtered voice signals.

12. A device according to claim 11, wherein the device is configured in such a manner that it is suitable for being housed in a seat.

13. A seat with a device for picking up and reproducing audio signals according to claim 11.

14. A seat with a device for picking up and reproducing audio signals according to claim 12.

15. A seat with a device for picking up and reproducing audio signals according to claim 11.

16. A hands-free unit having a device for picking up and reproducing audio signals according to claim 12.
